(19) United States
(12) Patent Application Publication
(10) Pub. No.: US 2008/0059522 A1
(43) Pub. Date: Mar. 6, 2008

(54) System and method for automatically creating personal profiles for video characters

(75) Inventors: Ying Li, Mohegan Lake, NY (US); Youngja Park, Edgewater, NJ (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 11/511,816

(22) Filed: Aug. 29, 2006

(51) Int. Cl. G06F 17/00

(52) U.S. Cl. 707/104.1

(57) ABSTRACT

A system, method and computer program product for generating personal profiles for subjects appearing in a video media source. The method includes extracting audiovisual-related personal information related to a subject appearing in the video media source; extracting text-related personal information that are related to the subject in the video source; correlating the extracted audiovisual-related personal information and the extracted text-related personal information related to the subject; and assembling a personal profile data structure for the subject, the personal profile data structure comprising the text-related personal information and audiovisual-related personal information related to the subject. The text-related personal information forms the name identity of the subject, while the audiovisual-related personal information includes audiovisual-related features including information forming one or more of: a visual identity, a kinematic identity and, a voice identity of the subject. In an alternate embodiment, in an iterative manner, the correlated extracted audiovisual-related personal information and extracted text-related personal information may be fed back and utilized for performing an additional search from external information sources, via a search engine, to obtain additional texts relating to the subject or obtain additional video media sources having the subject. There is further enabled the updating of an assembled personal profile of a subject as a new video media source having said subject becomes available.

### BACKGROUND OF THE INVENTION

1. Field of the Invention

The present invention relates generally to the field of multimedia content analysis and, more particularly, to a system and method for automatically creating personal profiles for video characters.

2. Description of the Prior Art

With the fast development of multimedia technology and the rapid growth of the Internet, a person can now basically find everything he/she wants from the world wide web (“Web”). One type of popular information that people usually search from the web is person-specific information. For instance, typing in “Tom Hanks” to find all information related to Tom Hanks (the actor perhaps). However, considering the overwhelming amount of information that can be obtained from the web, it would be desirable that there be implemented smart tools that can automatically collect the information related to a particular person, identify important pieces, assemble them into a personal profile and finally present the profile to the user for a view. Another example is to create such profiles for people who appear in a video (i.e., video characters). Generation of such profiles can benefit many multimedia applications such as personal activity tracking, information management and retrieval.

There has been some previous work on extracting person-specific information from video streams in the community of video content analysis. Some examples include voice-based person identification as described in the reference to Y. Li, S. Narayanan and C. Kuo, entitled “Adaptive Speaker Identification with Audiovisual Cues for Movie Content Analysis”, Pattern Recognition Letters, vol. 25, no. 7, 2004; face detection and recognition as described in the reference to E. Acosta, L. Torres, A. Albiol and E. Delp, entitled “An Automatic Face Detection and Recognition System for Video Indexing Applications”, IEEE International Conference on Acoustics, Speech and Signal Processing (ICASSP), 2002; as well as the detection of other soft biometrics such as gait as described in the reference to A. Bissacco, A. Chiuso, Y. Ma and S. Soatto, entitled “Recognition of Human Gaits”, IEEE Conference on Computer Vision and Pattern Recognition (CVPR), 2001. However, none of the existing work has ever attempted to extract various types of person-specific information such as name, affiliation, portrait and voice, from a video, and correlate them with each other for a particular video character. Such information extraction and assembly would require fairly sophisticated multimedia content analysis techniques.

There has heretofore never been provided a solution for enabling automatic creation of personal profiles for video characters, which contain various aspects of information that are specific to each individual character.

It would thus be highly desirable to have an implementation of media searching and data aggregation system and methodology for automatically creating personal profiles associated with video characters (i.e., characters appearing in a video media).

### SUMMARY OF THE INVENTION

In a broad sense, the present invention is directed to a system, method and computer program product for extracting various personal information with respect to an individual character who is appearing in a video media source, e.g., a video character. The extracted personal information data not only includes voice/speech information, but additionally other information such as affiliation, job title, face, gait, etc.

More particularly, a method and apparatus is provided for automatically extracting personal information and creating personal profiles for people that appear in video streams. Personal information that can be automatically extracted from videos may include name, affiliation, job position, face (or portrait), voice, motion (e.g. gait and gesture), and other related features. Specifically, extensive text analysis is first carried out on the video text (which includes video transcript, video scene texts, etc.) to identify various types of text-related personal identity information such as a character's name, affiliation, work location and job position. Different information pieces are then correlated and fused with each other across the entire video. This forms the name identities for video characters. Meanwhile, advanced audiovisual content analysis is carried out which extracts audiovisual-related personal identities from the video such as face, voice and motion. This forms the visual, voice and kinematics identities for video characters, respectively. For this invention, besides the information from the video and its text sources, both of the text and audiovisual content analysis processes can also access additional or external information sources such as the World Wide Web (WWW) and other private information databases (such as employee database and fingerprint or iris databases) for data enrichment purpose. Next, the text-related name identity and audiovisual-related visual, voice and kinematic identities that all refer to the same particular video character are correlated with each other based on advanced semantic context analysis. Finally, a personal profile for this video character is generated by assembling all of his or her identity information together.

Furthermore, in one aspect of the invention, various personal information with respect to an individual video character is extracted. Thus, not only does the personal profile include voice/speech information, but, in a much broader sense, also includes other information such as affiliation, job title, face, gait, gestures, etc. It is understood that the invention contemplates extracting features such as face, voice and gait from the video stream, with or without recognition. For example, the extracted visual information may be obtained without knowing the persons' names who “own” these features. Consequently, the invention relies upon the text mining tools to correlate a “name” with the extracted “features”. Similarly, as the extracted subject matter also includes extracted voice (or speech) information from the audio stream, it thus also relies on text mining tools (e.g. semantic context analysis) to correlate a person's “name” with his/her “voice”.

Thus, in accordance with the invention, there is provided a system, method and computer program product for generating a personal profile for a subject appearing in a video media source. The method includes:

extracting audiovisual-related personal information related to a subject appearing in the video media source;

extracting text-related personal information that is related to the subject in the video source;

correlating the extracted audiovisual-related personal information and the extracted text-related personal information related to the subject; and

assembling a personal profile data structure for the subject, the personal profile data structure comprising the text-related personal information and audiovisual-related personal information related to the subject.

Further to the system for generating personal profiles there is provided a means for extracting video texts from the video media source, as well as from other possible additional information sources, the text-related personal information extracting means receiving the extracted video texts to extract the text-related personal information.

The text-related personal information forms the name identity of the subject, while the audiovisual-related personal information includes audiovisual-related features including information forming one or more of: a visual identity, a kinematic identity, and a voice identity of the subject.

In an alternate embodiment, in an iterative manner, the correlated extracted audiovisual-related personal information and extracted text-related personal information may be fed back to a search engine means and utilized for performing an additional search to obtain additional texts relating to the subject or obtain additional video media sources having the subject.

Advantageously, the system and method for generating personal profiles further enables the updating an assembled personal profile of a subject as a new video media source having said subject becomes available.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts is a block diagram of a video processing system for automatically creating personal profiles for video character in accordance with a preferred embodiment of the invention;

FIG. 2 is a block diagram of a system for extracting texts pertaining to a video according to the methodology of the invention;

FIG. 3 is a block diagram of a system 100 for generating personal profiles for video characters according to the methodology of the invention;

FIG. 4 is a block diagram of a system 100′ for generating personal profiles for video characters in an iterative manner according to an alternate embodiment of the present invention;

FIG. 5 is a block diagram of adaptively updating pre-obtained personal profiles for video characters according to the present invention; and,

FIG. 6 is a block diagram depicting an example implementation of the current invention.

### DETAILED DESCRIPTION OF THE PREFERRED EMBODIMENTS

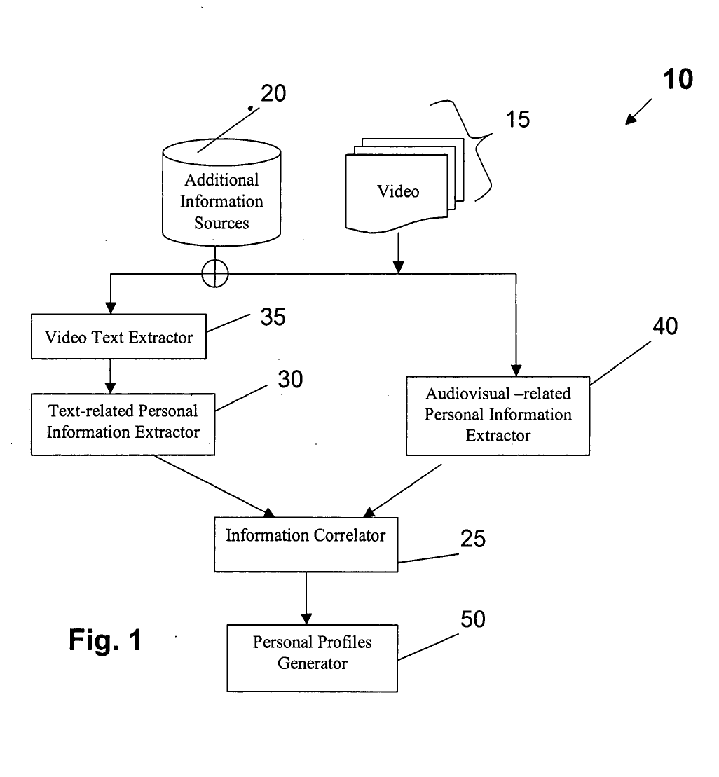

Referring now to drawings, and more particularly to FIG. 1, there is depicted a high-level overview of the personal profile generation for video characters. For purposes of discussion, in one embodiment of this invention, an example relating to the context of instructional videos such as training and education videos, will be described as these types of videos tend to present more complete and accurate information for its characters due to the nature of educational/training-type videos. However, it is understood that the techniques of the present invention may be extended and applied to other types of video sources as well.

In the high-level overview of the system 10 for generating personal profiles for video characters, shown in FIG. 1, an information correlator 25 is implemented to correlate various types of personal identity information that are extracted from both text and audiovisual sources of the video 15, as well as from additional information sources 20. As will be described in greater detail herein, a video text extractor module 35 is first applied to extract video texts from video 15, as well as from additional information sources 20. Two information extracting sub-systems including a text-related personal information extractor module 30 and an audiovisual (A/V)-related personal information extractor module 40 are then provided to extract both text-related and audiovisual-related personal identity information, respectively. These extracted information items are correlated and input to a personal profiles generator sub-system 50 to generate the personal profiles for video characters.

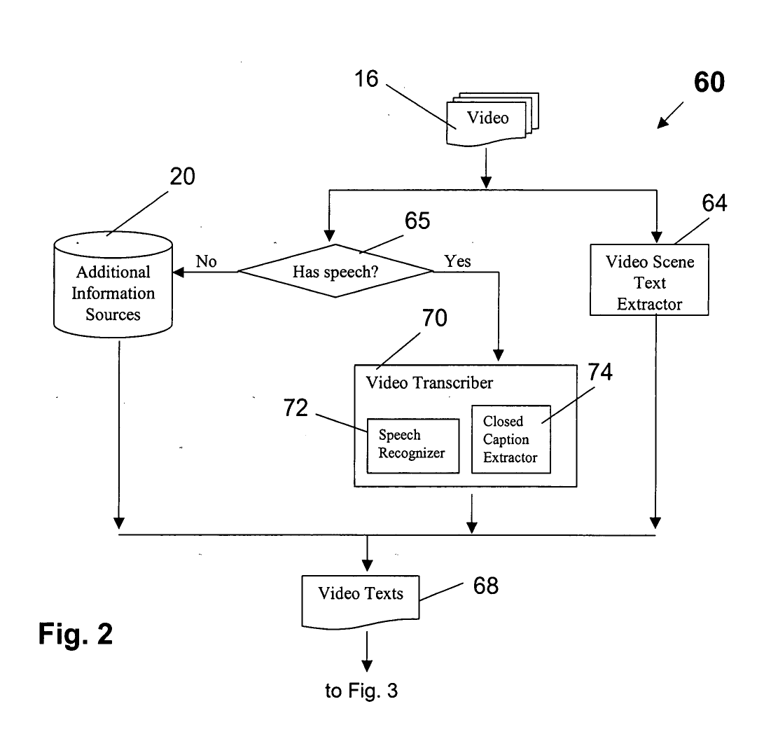

FIG. 2 depicts the process 60 of extracting text transcript as well as other texts that are related to a video. Specifically, as determined at step 65, if a video source 16, whether it be an MPEG file, wmv file, mov/avi file, MJPEG file, H.26x file, or any conceivable video format that contains speech, its transcript may be obtained using a video transcriber 70 that may include either a speech recognizer apparatus 72 or, a closed caption extractor 74; otherwise, additional information sources 20 such as text handouts or education materials that are related with the video may be relied upon. Finally, if the video source 16 contains scene texts, i.e. the texts that are displayed over video frames, they are input to a video scene text extractor 64 where the video scene texts are extracted and recognized as another text source. The scene text usually includes important information regarding the character, especially in instructional videos where scene texts are frequently used to inform the audience of the current speaker's name, job position, affiliation, etc. The outputs from the video transcriber 70, video scene text extractor 64, and from the additional information sources jointly form the video Texts 68.

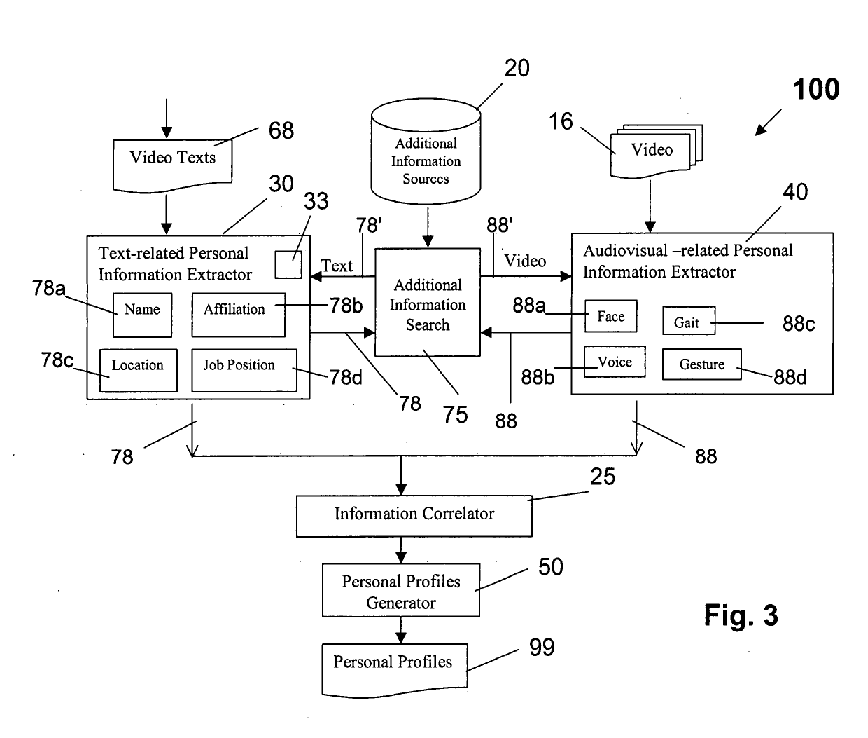

FIG. 3 depicts the process 100 implemented for generating personal profiles for video characters. Specifically, given the video text output 68 from FIG. 2, an advanced text analysis process is performed to extract various types of text-related personal identity information. Specifically, the video text data 68 is input to the text-related information extractor apparatus 30 in order to extract text-related personal information 78 including, but not limited to: the character's name 78a, affiliation 78b, work location 78c and job position 78d, etc. These information pieces are then correlated with each other across the entire video in the same apparatus 30. It is understood that the invention does not limit the types of information that can be extracted from the text. All information that are specific to video characters and can be robustly and effectively extracted can be incorporated into the inventive system.

This type of identity information is alternately referred to herein as name identity. One example is given here. For purposes of illustration, this example assumes that a character called Lisa Smith from OpenMind Company is introduced at the beginning of the video (denoted as a time instance A). Later on, when a person called Lisa is giving a speech and mentions that she works as a sales manager (denoted as a time instance B), a text analyzer 33 provided in the text-related personal information extractor module 30 is implemented to determine if this Lisa refers to Lisa Smith who is introduced earlier. If yes, then the analyzer 33 should be able to derive the fact that Lisa Smith is a sales manager at OpenMind Company, that is, to correlate and fuse various types of information that are related to one specific video character together, which may have been collected at different analysis stages.

Next, as shown in FIG. 3, this identity information 78 is optionally further fed into the additional information search engine 75 as a query seed, which searches and returns other related documents from additional information sources such as the World Wide Web and private databases. Now, for each returned document, if it is of video media type, it will be further fed into the audiovisual-related personal information extractor module 40, as will be detailed hereinbelow. Otherwise, this additional text source will be fed back to the text-related personal information extractor module 30 for further analysis. Information extracted from both internal and external text sources are then fused together to be part of the profile content. Using the exemplary scenario described hereinabove, assuming that text related affiliation information 78b is the OpenMind Company, this may be used as a keyword and submitted as a query in order to obtain a list of information items from the external source (e.g., the web) that are related with OpenMind Company. Now, for each returned document, if it is a text document, it is fed back into the text-related information extractor apparatus 30, which extracts other useful information such as the company's address (e.g. One Openmind Avenue, Blue Sky City, N.Y.). At this point, the character Lisa Smith's name identity will not only include her name (Lisa Smith), job position (sales manager), affiliation (OpenMind Company), but also her work location (One Openmind Avenue, Blue Sky City, N.Y.). Another searching example would be to submit “Lisa Smith and OpenMind Company” as a query, and then retrieve her educational and professional experiences, for example, from the web.

Contemporaneously with the extraction/processing of the text information related to the video, referring to FIG. 3, an audiovisual-related information extraction process is carried out to extract audiovisual-related personal information (or features) from the video source 16. Such audiovisual-related personal information may include, but are not limited to: a face 88a, voice 88b and motion features such as gait 88c and gesture 88d. These audiovisual-related personal features 88 can be expressed either as static features in a still image of form JPEG or BMP, or, in a short video or audio clip in the form of MPEG, MOV, AVI, WAV or MP3. It is understood that the invention does not limit the audiovisual features that can be extracted from video. All features that are specific to video characters and can be robustly and effectively extracted can be incorporated into the present invention. Some existing feature clustering approaches will then be applied to each category of features to cluster them into groups, where each group contains similar features. For instance, all extracted human faces can be grouped into classes, where each class contains similar faces that very likely correspond to the same video character. In the same manner, another set of groups can be formed where each group consists of similar voice information that pertains to the same person. According to the invention: 1) the face information forms the character's visual identity; 2) the voice information forms his/her voice identity; and 3) the motion information forms his/her kinematic identity.

Finally, referring to FIG. 3, all these three pieces of identity information 88 can be optionally fed into the additional information search engine 75 as query seeds, which searches and returns other related information from additional information sources 20 such as World Wide Web and private databases. It is understood that, based on the returned results from the search engine 75, different actions should be taken. Specifically, if the additional information search engine 75 returns text-oriented information, then the new information source 78′ will be further fed into the text-related personal information extractor module 30 for another round of text analysis/processing. Otherwise, if the additional information search engine 75 returns multimedia information such as videos and images 88′, then these new media content will be analyzed by the audiovisual-related personal information extractor module 40. One example that demonstrates the benefit of this additional step of information search is now provided. Assume that the former president Bill Clinton's face is detected and recognized in a video when a story about him is being told by a narrator, his face would then be submitted as a query to the web, which will likely return some videos where Bill Clinton himself is giving a speech. The audiovisual-related personal information extractor module 40 will then extract his voice from those videos, and relate Bill Clinton's face with his voice.

Continuing, when all identity information including the name, visual, voice and kinematics identities that relates to various video characters are extracted and finalized, they are fed into the information correlator module 25 to be correlated with each other. As known in the art, complex and advanced semantic context analysis may be performed in the information correlator module 25. For example, assuming from the text-related personal information extractor module 30 that Lisa Smith's name identity is obtained, and from the audiovisual-related personal information extractor module 40, a set of visual, voice and kinematics identities for multiple video characters are obtained whose names are still unknown (i.e., it is only known from the audiovisual-related personal information extractor module 40 that this group includes faces, voices or motions that corresponding to one specific video character, but it is not known who he or she is). Then, the information correlator module 25 will determine which visual, voice and kinematics identities belong to the character Lisa Smith. One approach to fulfill this task is to perform context analysis. For instance, if it is known that starting from time instance B, Lisa Smith is giving a speech, which could be derived from extracted text cues (e.g., a sentence which says “now, let's welcome Lisa Smith to give us a speech”), then it is possible to correlate Lisa's name identity with the visual identity that contains the face extracted at time instance B. In the same manner, the example Lisa Smith's voice and kinematics identities can be identified. Another example of performing such information correlation is to take advantage of the cues from the video scene texts. As mentioned hereinabove, scene texts are frequently used to inform the audience of the current speaker's name, job position, affiliation, etc. Therefore, if it is detected that there is a person who is present in the current frame with superimposed video texts showing the name, job position and affiliation, the person's visual identity can be easily correlated with his or her name identity. Moreover, if it is further detected that the person is also speaking at that time, then his or her voice identity will also be correlated.

Finally, as shown in FIG. 3, a personal profile creation process is applied to assemble all obtained and correlated identity information with respect to a specific video character, and generates his or her personal profile 99. When a video contains multiple characters, multiple personal profiles may be generated. The profiles could be stored in a database table, where each table row (also known as item or record) corresponds to the profile of one specific video character, and each table column (also known as field) corresponding to one particular type of identity information. Typically, one video will have one such profile table. Once stored, the profile information can then be presented to viewers in various ways. One typical way is to aesthetically layout various identity information in a web page like what people do with their personal homepages.

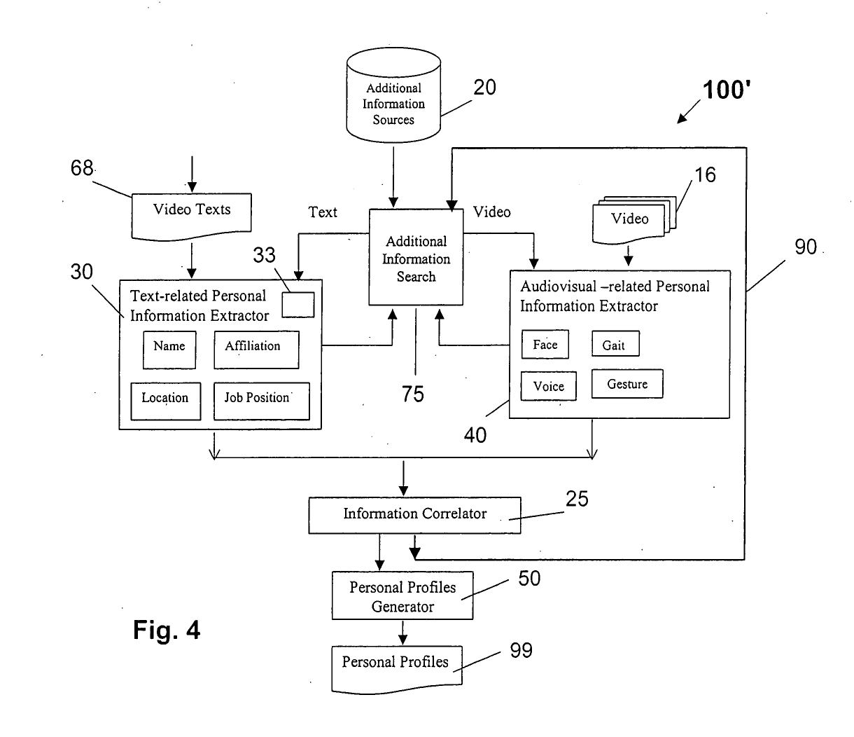

FIG. 4 is a block diagram of an alternate embodiment of the system 100 depicted in FIG. 3 and particularly a system 100′ for generating personal profiles for video characters in an iterative manner according to an alternate embodiment of the present invention. Compared to the system 100 described herein with respect to FIG. 3, the alternate embodiment of the system 100′ depicted in FIG. 4, implements an iterative loop 90. Specifically, after the step of applying the information correlator module 25 to correlate a video character's name identity with his or her visual, voice and kinematics identities, all these identity information can be treated as a whole and fed back to the additional information search engine 75, which may be used to identify more personal information with respect to the character in the manner as described herein. Moreover, this iterative process can help increase the accuracy of the collected information, thus reducing the errors of including imprecise information in profiles.

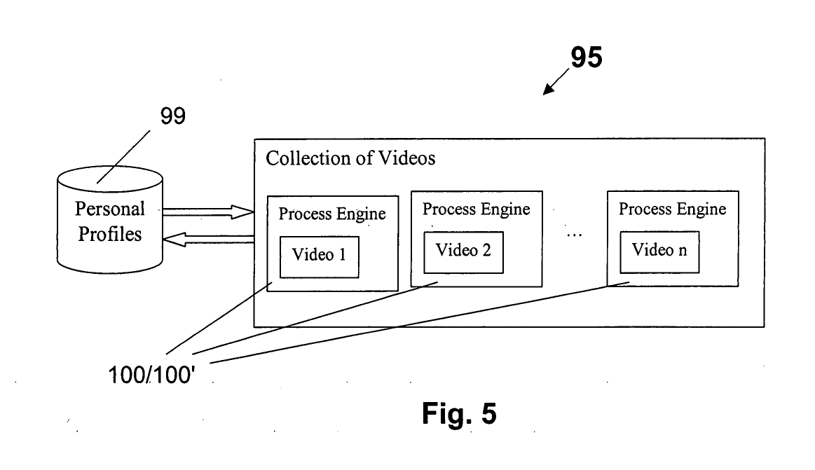

FIG. 5 conceptually depicts a method and system 95 for adaptively updating pre-obtained personal profiles by applying them to one or more other videos. Specifically, using pre-obtained profiles 99 stored in a database, for example, as the basis, it is possible to discover more personal information regarding those characters from these new videos, depicted in FIG. 5 as Video 1, Video 2, . . . , Video n, and, subsequently, use them to enrich the profiles. One example is now described in the context of the example company OpenMind. Assume that Lisa Smith's profile is obtained from Video A, and then in Video B, it is discovered that it also contains a character called Lisa Smith, who also works for OpenMind Company. It can then be derived that this Lisa Smith in Video B is the same one as in Video A, thus her profile constructed for Video A could be applied to Video B (another possible scenario is that it is already known that Lisa Smith appears in a series of videos). Any additional information that may be derived from Video B for Lisa Smith would be appended to this profile. As a result, with such an adaptive process, profiles can be gradually obtained with richer and more complete information. It is thus understood that, in the system described with respect to FIG. 5, each video process engine represents the end-to-end processes 100/100′ as described in FIG. 3 or FIG. 4.

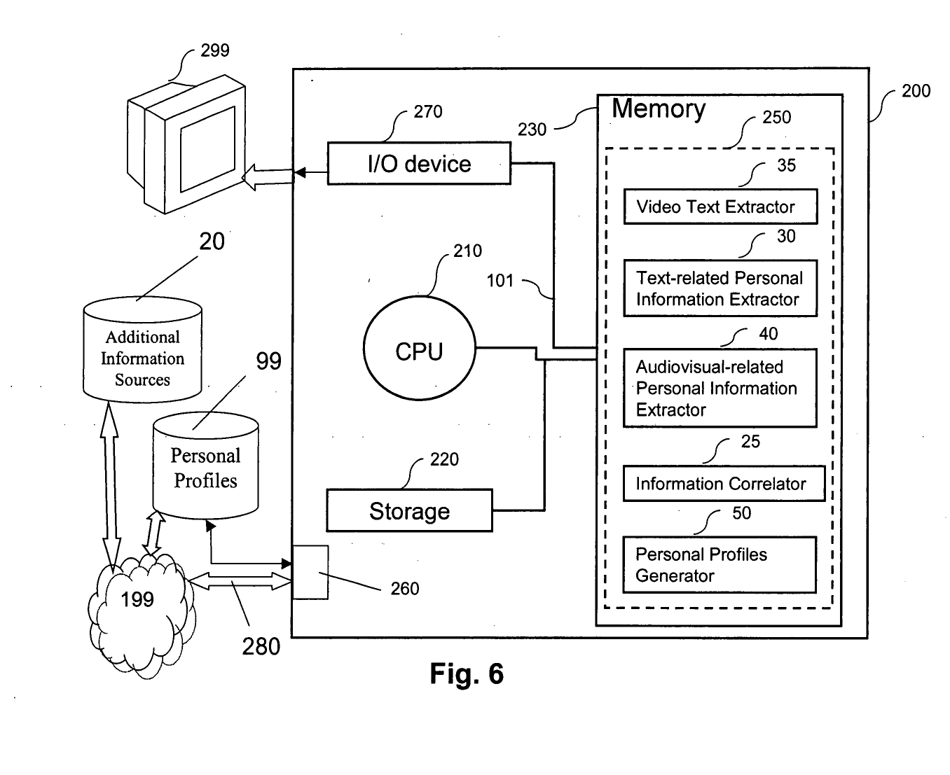

FIG. 6 depicts a block diagram of an example computing system 200 adapted for implementing the personal profile generation technique for video characters of the present invention. In the preferred embodiment, system implementation 200 is a computing environment or computing node such as a personal computer (PC), workstation, mobile or laptop computer, or a pervasive digital device (e.g., PDA) that is able to load and execute programmatic code, including, but not limited to: products sold by IBM such as ThinkPad® or PowerPC®, running the operating system (O/S) and server application suite sold by Microsoft, e.g., Windows® XP, or a Linux operating system. It is understood that other operating systems including Linux, various Unix O/Ss, Macintosh, MS Windows OS, and the like, may be used to control execution of the personal profile generation functionality of the invention. According to the present invention, the processing engine implementing logic 250 of the invention is preferably embodied as computer executable code that is loaded from a remote source (e.g., from a network file system), local permanent optical storage (CD-ROM), magnetic storage (such as disk), or like storage device 220 into memory 230 (e.g., nonvolatile memory such as RAM) for execution by a CPU 210. As will be discussed in greater detail below, the memory 230 preferably includes computer readable instructions, data structures, program modules, and application interfaces forming the following components: video text extractor module 35, text-related personal information extractor module 30, audiovisual (A/V)-related personal information extractor module 40, information correlator 25 and personal profile generator 50. The video text extractor module 35 preferably comprises a set of executable computer instructions for performing video transcription, video scene text extraction, and obtaining related text materials from additional information sources, while the information correlator 25 and personal profile generator 50 preferably comprise a set of executable computer instructions capable of performing the respective information correlation and personal profile assembly for video characters according to the invention.

The computer system 200 also includes a display device 299 or like monitor and associated I/O device, e.g., video adapter device 270 that couples the display device 299 to a system bus 101 implemented for connecting various system components together. For instance, the bus 101 connects the CPU or like processor 210 to the RAM or other system memory 230. The bus 101 can be implemented using any kind of bus structure or combination of bus structures, including a memory bus or memory controller, a peripheral bus, an accelerated graphics port, and a processor or local bus using any of a variety of bus architectures such as ISA bus, an Enhanced ISA (EISA) bus, and a Peripheral Component Interconnects (PCI) bus or like bus device. The computer node 200 implements functionality for providing a user interface for initiating and controlling execution of the respective video text extraction, text-related personal information extraction, audio/video-related personal information extraction, information correlation and personal profile generation aspects of the invention, via the associated display device 299. Although not shown, the computing node 200 includes other user input devices such as a keyboard, and a pointing device (e.g., a “mouse”) for entering commands and information into the computer (e.g., data storage devices), and, particularly, for searching additional information from additional or external information sources, visualizing the extracted text-related personal information and audiovisual-related personal information, and presenting the generated personal profiles to users enabled by the invention via a user interface generated on the display device 299.

As mentioned herein, the computer system 200 is adapted to operate in a networked environment for conducting searches and receiving information from additional information sources 20, e.g., a web-site and a database server. As shown in FIG. 6, it is understood that any type of network 199 can be used to couple the computer system 200 with an external information source such as a local area network (LAN), or a wide area network (WAN) (such as the Internet). When implemented in a LAN networking environment, the computer 200 connects to the local network via a network interface or adapter 260, e.g., that supports Ethernet. When implemented in a WAN networking environment, the computer 200 connects to the WAN via a high bandwidth cable/dsl modem 280 or some other wired and/or wireless connection means. The cable/dsl modem 280 can be located internal or external to computer 200, and can be connected to the bus 101 via an I/O interface or other appropriate coupling mechanism (not shown). Although not illustrated, the computing environment 200 can provide wireless communication functionality for connecting computer 200 with another remote computing device, e.g., an application server (e.g., via modulated radio signals,.modulated infrared signals, etc.).

It should be understood that other kinds of computer and network architectures are contemplated. For example, although not shown, the computer system 200 can include hand-held or laptop devices. It is further understood that the computing system 200 can employ a distributed processing configuration. In a distributed computing environment, computing resources for implementing the video text extractor module 35, text-related personal information extractor module 30, audiovisual (A/V)-related personal information extractor module 40, information correlator 25 and personal profile generator 50 can be physically dispersed.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention.

Having thus described our invention, what we claim as new, and desire to secure by Letters Patent is:

1. A system for generating a personal profile for a subject appearing in a video media source, said system comprising:
a means for extracting audiovisual-related personal information related to said subject appearing in said video media source;
a means for extracting text-related personal information that are related to said subject in said video source;
a means for correlating said extracted audiovisual-related personal information with said extracted text-related personal information to form a personal profile for said subject, said personal profile comprising a data structure including said text-related personal information and audiovisual-related personal information related to said subject.

2. The system for generating a personal profile as claimed in claim 1, further comprising:
a means for extracting video texts from one of: said video media source and additional information sources, said text-related personal information extracting means receiving said extracted video texts to extract said text-related personal information.

3. The system for generating a personal profile as claimed in claim 1, wherein said audiovisual-related personal information includes audiovisual-related features that pertain to personal identity comprising one or more of: a visual identity, a kinematic identity, and a voice identity of said subject.

4. The system for generating a personal profile as claimed in claim 3, wherein said audiovisual-related features forming said kinematic identity comprise a video clip showing motion including a gait or gesture of said subject.

5. The system for generating a personal profile as claimed in claim 3, wherein said audiovisual-related features forming said visual identity comprise the face of said subject.

6. The system for generating a personal profile as claimed in claim 3, wherein said audiovisual-related features forming said voice identity comprise an audio clip of said subject's voice.

7. The system for generating a personal profile as claimed in claim 2, wherein said extracted text-related personal information comprises personal information associated with said subject that can be automatically extracted from a video media source.

8. The system for generating a personal profile as claimed in claim 7, wherein said extracted text-related personal information includes text-related personal identity information including one or more of: a subject's name, affiliation, and job position.

9. The system for generating a personal profile as claimed in claim 2, wherein said means for extracting video texts that are related to a video source includes one or more of: a video scene text extractor for extracting texts that are displayed over video frames, and a video transcriber device.

10. The system for generating a personal profile as claimed in claim 2, wherein said means for extracting video texts from additional information sources includes obtaining text materials that are related to the said video source from said additional information sources.

11. The system for generating a personal profile as claimed in claim 9, wherein said video transcriber device includes one of: a speech recognizer and a closed caption extractor.

12. The system for generating a personal profile as claimed in claim 7, further comprising: a search engine means for receiving said extracted text-related personal information relating to said subject and performing a search from additional information sources to obtain additional texts relating to said subject or obtain additional video media sources having said subject.

13. The system for generating a personal profile as claimed in claim 12, wherein said search engine means further receives said extracted audiovisual-related personal information related to said subject appearing in said video media source and performs a search from said additional information sources to obtain additional texts relating to said subject or obtain additional video media sources having said subject.

14. The system for generating a personal profile as claimed in claim 12, wherein said search engine means performs one or more of: an Internet/World Wide Web search, and a database search.

15. The system for generating a personal profile as claimed in claim 1, wherein said correlating means comprises means for performing semantic context analysis for correlating said extracted audiovisual-related personal information with said extracted text-related personal information.

16. The system for generating a personal profile as claimed in claim 15, wherein said correlated extracted audiovisual-related personal information and extracted text-related personal information output from said correlating means is input to said search engine means for performing an additional search from additional information sources to obtain additional texts relating to said subject or obtain additional video media sources having said subject.

17. The system for generating a personal profile as claimed in claim 1, further comprising means for updating an assembled personal profile of a subject as a new video media source having said subject becomes available.

18. A method for generating a personal profile for a subject appearing in a video media source, said method comprising:
extracting audiovisual-related personal information related to said subject appearing in said video media source;
extracting text-related personal information that are related to said subject in said video source;
correlating said extracted audiovisual-related personal information with said extracted text-related personal information related to said subject; and
assembling a personal profile data structure for said subject, said personal profile data structure comprising said text-related personal information and audiovisual-related personal information related to said subject.

19. The method for generating a personal profile as claimed in claim 18, wherein said extracting of text-related personal information comprises:
extracting video texts from one of: said video media source and additional information sources, said text-related personal information related to said subject being extracted from said extracted video texts.

20. The method for generating a personal profile as claimed in claim 19, wherein said extracting video texts from said video media source includes implementing one or more of: a video scene text extractor for extracting texts that are displayed over video frames, and a video transcriber device.

21. The method for generating a personal profile as claimed in claim 19, wherein said extracting video texts from said additional information sources includes obtaining text materials that are related to the said video source from external information sources.

22. The method for generating a personal profile as claimed in claim 20, wherein said video transcriber device includes one of: a speech recognizer, and a closed caption extractor.

23. The method for generating a personal profile as claimed in claim 18, further comprising:
receiving, by a search engine means, one or more of: said extracted text-related personal information relating to said subject, and said extracted audiovisual-related personal information related to said subject, and,
performing a search, via said search engine means, to obtain additional texts relating to said subject or obtain additional video media sources having said subject.

24. The method for generating a personal profile as claimed in claim 18, wherein said correlating includes performing semantic context analysis for correlating said extracted audiovisual-related personal information with said extracted text-related personal information.

25. The method for generating a personal profile as claimed in claim 24, further comprising:
receiving, at said search engine means, said correlated extracted audiovisual-related personal information and extracted text-related personal information output from said correlating means;
performing an additional search to obtain additional texts relating to said subject or obtain additional video media sources having said subject; and,
conducting additional audiovisual-related personal information and text-related personal information extracting steps and correlating said extracted additional audiovisual-related personal information with said extracted additional text-related personal information related to said subject prior to assembling said personal profile data structure for said subject.

26. The method for generating a personal profile as claimed in claim 18, further comprising updating an assembled personal profile of a subject as a new video media source having said subject becomes available.

27. A program storage device tangibly embodying software instructions which are adapted to be executed by a machine to perform a method of generating a personal profile for a subject appearing in a video media source, said method comprising:
extracting audiovisual-related personal information related to said subject appearing in said video media source;
extracting text-related personal information that are related to said subject in said video source;
correlating said extracted audiovisual-related personal information with said extracted text-related personal information related to said subject; and
assembling a personal profile data structure for said subject, said personal profile data structure comprising said text-related personal information and audiovisual-related personal information related to said subject.

28. The program storage device tangibly embodying software instructions as claimed in claim 27, wherein said extracting of text-related personal information comprises:
extracting video texts from one of: said video media source and additional information sources, said text-related personal information related to said subject being extracted from said extracted video texts.

29. The program storage device tangibly embodying software instructions as claimed in claim 28, wherein said extracting video texts from said video media source includes implementing one or more of: a video scene text extractor for extracting texts that are displayed over video frames, and a video transcriber device.

30. The program storage device tangibly embodying software instructions as claimed in claim 28, wherein said extracting video texts from said additional information sources includes obtaining text materials that are related to the said video source from external information sources.

31. The program storage device tangibly embodying software instructions as claimed in claim 29, wherein said video transcriber device includes one of: a speech recognizer, and a closed caption extractor.

32. The program storage device tangibly embodying software instructions as claimed in claim 27, further comprising:
receiving, by a search engine means, one or more of: said extracted text-related personal information relating to said subject, and said extracted audiovisual-related personal information related to said subject, and,
performing a search, via said search engine means, to obtain additional texts relating to said subject or obtain additional video media sources having said subject.

33. The program storage device tangibly embodying software instructions as claimed in claim 27, wherein said correlating includes performing semantic context analysis for correlating said extracted audiovisual-related personal information with said extracted text-related personal information.

34. The program storage device tangibly embodying software instructions as claimed in claim 33, further comprising:
receiving, at said search engine means, said correlated extracted audiovisual-related personal information and extracted text-related personal information output from said correlating means;
performing an additional search to obtain additional texts relating to said subject or obtain additional video media sources having said subject; and,
conducting additional audiovisual-related personal information and text-related personal information extracting steps and correlating said extracted additional audiovisual-related personal information with said-extracted additional text-related personal information related to said subject prior to assembling said personal profile data structure for said subject.

35. The program storage device tangibly embodying software instructions as claimed in claim 27, further comprising updating an assembled personal profile of a subject as a new video media source having said subject becomes available.
